(19) United States
(12) Patent Application Publication
(10) Pub. No.: US 2009/0225731 A1
(43) Pub. Date: Sep. 10, 2009

(54) Wireless network including request to trigger function

(75) Inventors: Jarkko Kneckt, Espoo (FI); Janne Marin, Espoo (FI); Mika Kasslin, Espoo (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/075,368

(22) Filed: Mar. 10, 2008

(51) Int. Cl. H04Q 7/24; G08C 17/00

(52) U.S. Cl. 370/338; 370/311

(57) ABSTRACT

In one aspect thereof the invention provides a method that includes transmitting a beacon frame from a first mesh point to a second mesh point; determining if a trigger frame is received at the first mesh point within some predetermined period of time from the second mesh point and, if the trigger frame is not received, transmitting a request to trigger frame from the first mesh point to the second mesh point. In another aspect thereof the invention provides a method that includes receiving a request to trigger frame at a first mesh point from a second mesh point and in response, transmitting an acknowledgment to the request to trigger frame to the second mesh point. A computer-readable medium storing program instructions to implement the methods is also disclosed, as are corresponding apparatus.

### TECHNICAL FIELD

The exemplary and non-limiting embodiments of this invention relate generally to wireless communication systems, methods, devices and computer programs and, more specifically, relate to power management techniques therefore.

### BACKGROUND

The following abbreviations are utilized herein:

802.1 Is mesh networking described by the IEEE 802.11s draft amendment

ACK acknowledgement (acknowledgement message)

AP access point

ATIM announcement traffic indication message

BSS basic service set

DTIM delivery traffic indication message

GAS generic advertisement service

IBSS independent basic service set

IEEE institute of electrical and electronics engineers

MAC medium access control (layer 2, L2)

MAP mesh access point

MP mesh point

MSDU MAC service data unit

PS power save

STA station

TBTT target beacon transmission time

TIM traffic indication message

WLAN wireless local area network

One publication of interest to the ensuing description is:

IEEE P802.11s™/D1.08, Draft STANDARD for Information Technology-Telecommunications and information exchange between systems Local and metropolitan area networks Specific requirements Part 11: Wireless LAN Medium Access Control (MAC) and Physical Layer (PHY) specifications Mesh Networking (January 2008).

In accordance with draft 1.08 of 802.11s, coordination of devices within radio range is achieved by the exchange of beacon frames. Periodic beacon transmission enables device discovery, supports dynamic network organization, and provides support for mobility.

As described in the IEEE P802.11s™ Draft Standard, in section 5.2.9.1 “Introduction to mesh”, in WLAN deployments without mesh services, stations (STAs) must associate with an access point (AP) in order to gain access to the network. These STAs are dependent on the AP with which they are associated to communicate. An example of a nonmesh WLAN deployment model and device classes are illustrated herein in FIG. 1, which reproduces Figure s1 of the IEEE P802.11s™ Draft Standard.

Many WLAN devices can benefit from support for more flexible wireless connectivity. Functionally, the distribution system of an access point can be replaced with wireless links or multihop paths between multiple APs. Devices traditionally categorized as clients can benefit from the ability to establish peer-to-peer wireless links with neighboring clients and APs in a mesh network.

An example of a mesh is depicted in FIG. 2, which reproduces Figure s2 of the IEEE P802.11s™ Draft Standard. Mesh points (MPs) are entities that support mesh services, i.e., they participate in the formation and operation of the mesh network. An MP may be collocated with one or more other entities (e.g., AP, portal, etc.). The configuration of an MP that is collocated with an Access Point is referred to as a mesh access point (MAP). Such a configuration allows a single entity to logically provide both mesh functionalities and AP functionalities simultaneously. STAs associate with APs to gain access to the network. Only MPs participate in mesh functionalities such as path selection and forwarding, etc. Mesh portals (MPPs) interface the network to other IEEE 802 LAN segments.

As is stated in section 5.2.9.2, “Mesh network model”, of the IEEE P802.11s™ Draft Standard, a mesh network is an IEEE 802 LAN comprised of IEEE 802.11 links and control elements to forward frames among the network members. Effectively, this means that a mesh network appears functionally equivalent to a broadcast Ethernet from the perspective of other networks and higher layer protocols. Thus, it normally appears as if all MPs in a mesh are directly connected to the link layer. This functionality is transparent to higher layer protocols. Reference in this regard can be made to FIG. 3A, which reproduces Figure s-3 of the IEEE P802.11s™ Draft Standard. It should be noted that while this figure shows the forwarding of data over multiple hops, there may also be direct data transfer over a single hop, such as is shown in FIG. 3B, wherein the source and destination of the MSDUs are within a one-hop neighborhood, and where no forwarding, routing or link metric need be used.

In an infrastructure Basic Service Set (BSS) stations rely on the AP for power saving. A station informs the AP before switching from active to power save mode. If any STA in BSS operates in power save mode, the AP buffers multicast and broadcast traffic and delivers the traffic after the Delivery Traffic Indication Message (DTIM) period. The DTIM interval is a multiple of beacon periods. For unicast traffic that is buffered in the AP, stations periodically need to wake up to receive the Traffic Indication Map (TIM) that is present in all beacon frames. Having learned from a beacon frame that unicast traffic directed to the station is pending, a station sends out a Power Save (PS)-Poll frame to request the traffic's delivery from the AP.

In an independent basic service set (IBSS) mode, also known as ad-hoc, the basic approach is similar to the infrastructure BSS case in that the STAs are synchronized, and multicast traffic and the traffic that are to be transmitted to a power-conserving STA are first announced during a period when all STAs are awake. The announcement is performed via a message sent in an ATIM Window. A STA in the power save mode shall listen for these announcements to determine if it needs to remain in the awake state. The presence of the ATIM window in the IBSS indicates if the STA may use the PS Mode. To maintain correct information on the power save state of other STAs in an IBSS, a STA needs to remain awake during the ATIM window. At other times, the STA may enter the doze state.

The current specification of 802.11s specifies two different power states. In the awake state, the MP is able to transmit or receive frames and is fully powered, while in the doze state the MP is not able to transmit or receive and consumes very low power. The transitions between these two power states are determined by the MP power management modes, i.e., an active mode where the MP shall be in the awake state all the time and the power save mode where the MP alternates between awake and doze states. There may be further power save modes, for example, a deep sleep mode where the MP transmits its delivery traffic indication message (DTIM) beacon and stays active during its own awake window after its DTIM beacon. Another mode may be a light sleep mode. If the peer MP operates in this mode, the MP transmits its traffic indication map (TIM) and DTIM beacons and stays awake during its awake window after its DTIM beacon and after its TIM beacon with the awake window information element. The MP listens to all the beacons from all peer MPs to which it has indicated to operate in light sleep mode. The DTIM period is defined per Mesh Point.

Further rules for how the communication to and from the MP in power save can be triggered are defined. The MP which transmitted the beacon operates in the awake state until it has received a trigger frame from all peer MPs which have indicated to operate in a power save mode where they are listening to beacons (e.g. light sleep mode), and the beaconing MP has indicated availability of buffered traffic for the peer MPs in its beacon frame. However, the nature of the radio environment and protocol is such that the MP cannot be sure that all peer MPs that have indicated to operate in such a power save mode have received the beacon. Thus, if the peer MP does not receive the beacon correctly, the MP does not know that it should transmit a trigger frame to the beaconing MP. In this case, the beaconing MP must stay in the awake state until it receives a frame from the peer MP that can be interpreted as a trigger frame, or indicates in its own consecutive beacon that it does not have any frames to transmit.

The behavior described in the previous paragraph results in power inefficiency in the beaconing MP, and may cause additional delays in frame transmission.

### SUMMARY

The foregoing and other problems are overcome, and other advantages are realized, by the use of the exemplary embodiments of this invention.

In a first aspect thereof the exemplary embodiments of this invention provide a method that comprises transmitting a beacon frame from a first mesh point to a second mesh point; determining if a trigger frame is received at the first mesh point within some predetermined period of time from the second mesh point and, if the trigger frame is not received, transmitting a request to trigger frame from the first mesh point to the second mesh point.

In another aspect thereof the exemplary embodiments of this invention provide a computer-readable medium that stores program instructions, the execution of which results in operations that comprise transmitting a beacon frame from a first mesh point to a second mesh point; determining if a trigger frame is received at the first mesh point within some predetermined period of time from the second mesh point; and if the trigger frame is not received, transmitting a request to trigger frame from the first mesh point to the second mesh point.

In another aspect thereof, the exemplary embodiments of this invention provide an apparatus that includes a wireless transmitter that comprises part of a first mesh point; a wireless receiver that comprises part of the first mesh point and a control unit configurable to transmit a beacon frame from the first mesh point to a second mesh point. The control unit is further configurable to determine if a trigger frame is received from the second mesh point within some predetermined period of time and, if the trigger frame is not received, to transmit a request to trigger frame to the second mesh point.

In a further aspect thereof, the exemplary embodiments of this invention provide a method that comprises receiving a request to trigger frame at a first mesh point from a second mesh point and in response, transmitting an acknowledgment to the request to trigger frame to the second mesh point.

In another aspect thereof, the exemplary embodiments of this invention provide a computer-readable medium that stores program instructions, the execution of which results in operations that comprise receiving a request to trigger frame at a first mesh point from a second mesh point and in response, transmitting an acknowledgment to the request to trigger frame to the second mesh point.

In yet another aspect thereof the exemplary embodiments of this invention provide an apparatus that includes a wireless transmitter that comprises part of a first mesh point; a wireless receiver that comprises part of the first mesh point and a control unit configurable to respond to a receipt of a request to trigger frame from a second mesh point by transmitting an acknowledgment to the request to trigger frame to the second mesh point.

### BRIEF DESCRIPTION OF THE DRAWINGS

In the attached Drawing Figures:

FIG. 1 reproduces Figure s1 of the IEEE P802.11s™ Draft Standard, and shows a nonmesh IEEE 802.11 deployment model and device classes;

FIG. 2 reproduces FIG s2 of the IEEE P802.11s™ Draft Standard, and shows a mesh containing MPs, MAPs, and STAs;

FIG. 3A reproduces Figure s3 of the IEEE P802.11s™ Draft Standard, and shows MAC data transport over a Mesh;

FIG. 3B depicts an exemplary ad-hoc one hop networking model;

FIG. 4 shows a simplified block diagram of various electronic devices that are suitable for use in practicing the exemplary embodiments of this invention;

FIG. 5 reproduces FIG. 7-18 of the IEEE P802.11s™ Draft Standard, and shows the management frame format.

FIG. 6 reproduces Table 7-8 of the IEEE P802.11s™ Draft Standard, and shows the beacon frame body format.

FIG. 7 is a logic flow diagram that illustrates the operation of a method by a beaconing MP, and a result of execution of computer program instructions, in accordance with the exemplary embodiments of this invention.

FIG. 8 is a logic flow diagram that illustrates the operation of a method by a peer MP, and a result of execution of computer program instructions, in accordance with the exemplary embodiments of this invention.

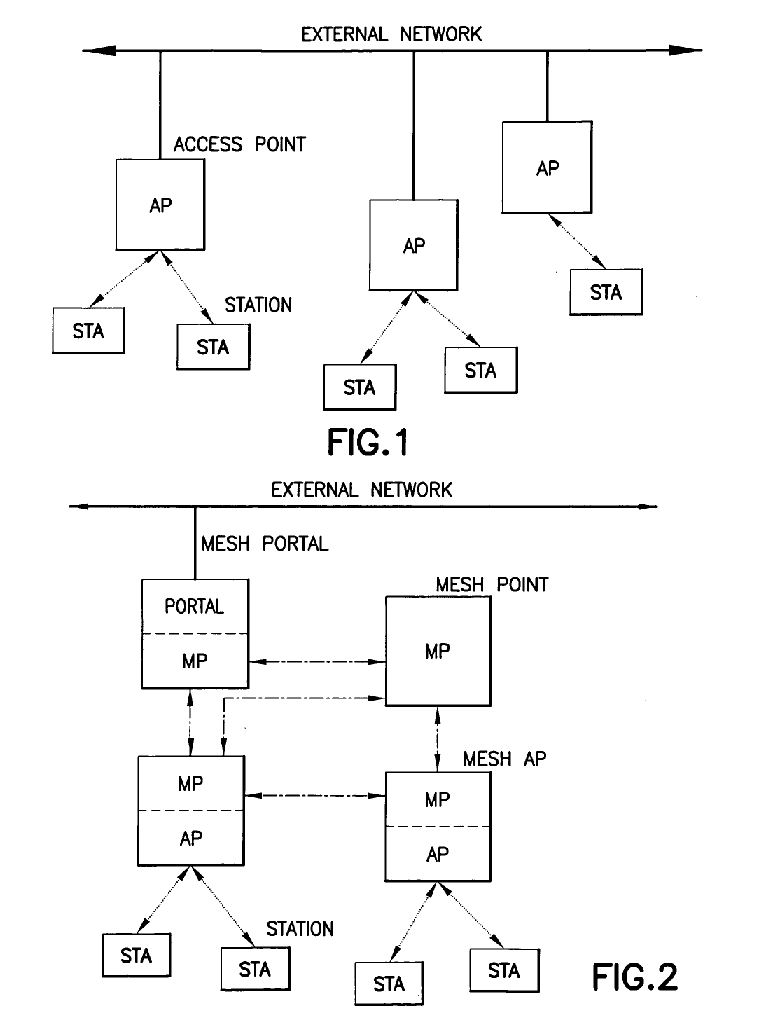

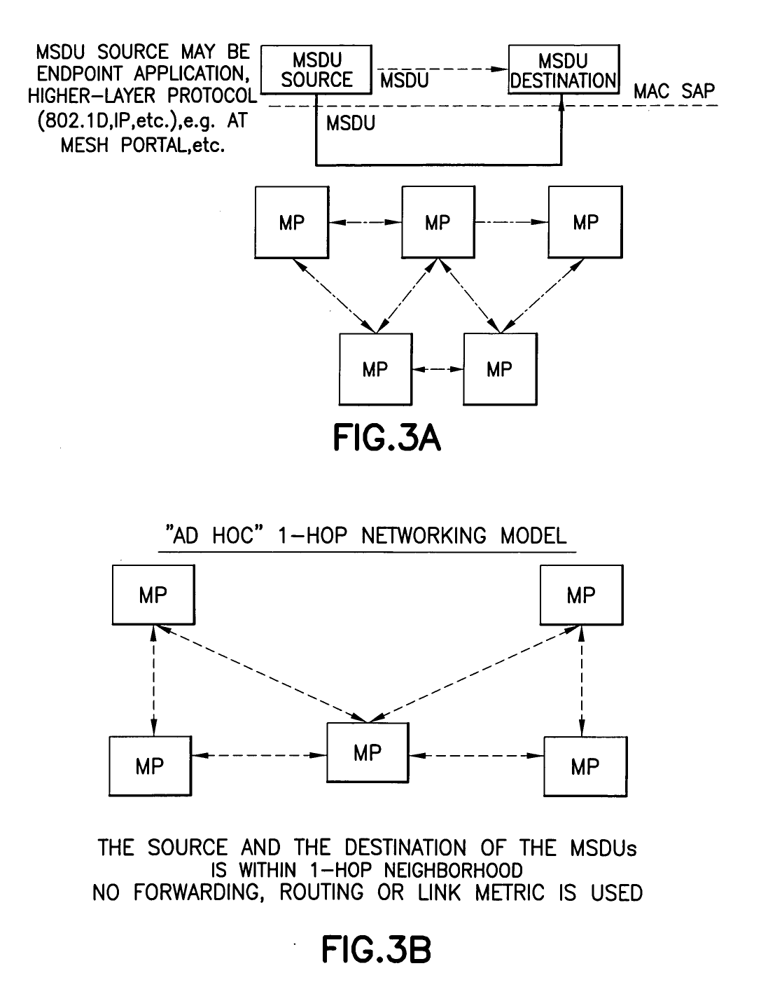

### DETAILED DESCRIPTION

As described in greater detail below, the exemplary embodiments of the invention provide power saving in WLAN MESH networks, in WLAN ad-hoc networks and in other wireless networks.

The exemplary embodiments of the invention improve behavior of the nodes using a “request to trigger” approach, where a request to trigger indication in a frame, that may be transmitted as a unicast frame, is used to request the receiver of the frame to send a trigger frame.

Between a first device and a second device in a mesh network (e.g., 802.11s), the second device is considered a “peer MP” of the first device if there is an authenticated communication link between the first device and the second device (i.e., a communication link with one or more messages being directed from/to the first device to/from the second device, also referred to as a peer link). A non-peer MP is only able to use frames that do not require authentication when communicating with the other MP. Non-limiting examples of such frames include probe requests, peer link open frames or Generic Advertisement Service (GAS) query frames. As an example, a non-peer MP may receive a beacon message from a first device and respond with a frame in an attempt to establish a peer relationship with the first device.

For reference purposes, a “beaconing MP” refers to the MP that transmits the beacon. Generally, this term will be used in conjunction with a non-peer MP that receives the beacon from the beaconing MP and desires to establish a peer relationship by responding to the beacon (i.e., transmitting a frame to the beaconing MP).

A trigger frame is used to initiate a service period. The mesh point (beaconing MP) that receives the trigger frame transmits all or at least part of buffered traffic to the mesh point (peer MP) that has initiated the service period. The transmission start of the buffered traffic may be done immediately, or it may be delayed until after the reception of the trigger frame.

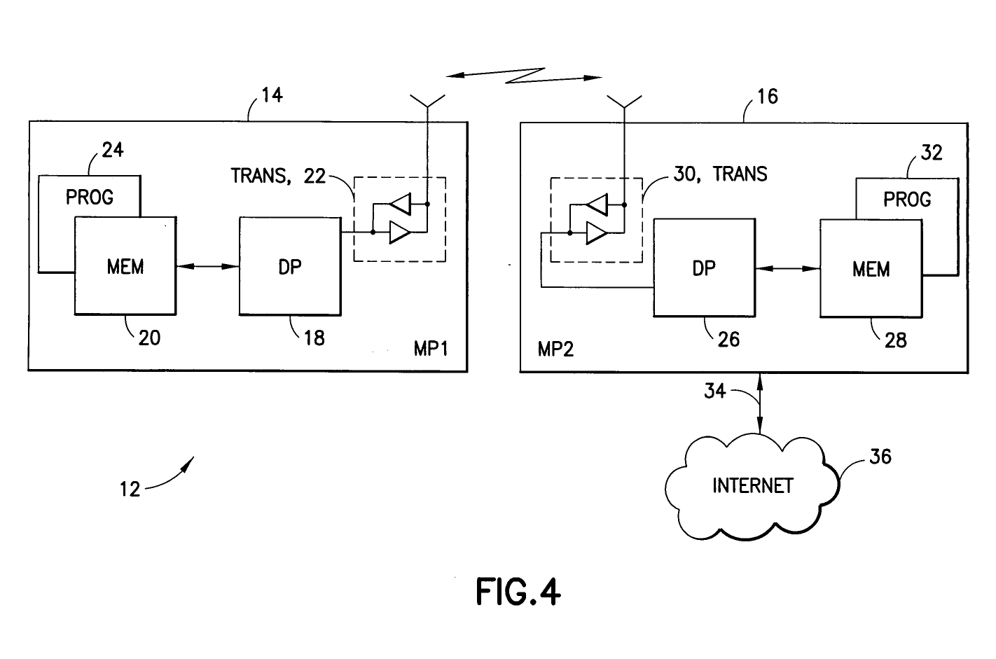

Reference is made to FIG. 4 for illustrating a simplified block diagram of various electronic devices that are suitable for use in practicing the exemplary embodiments of this invention. In FIG. 4, a wireless network 12 is adapted for communication with a first mesh point (MP1) 14 via a second mesh point (MP2) 16. The MP1 14 includes a control unit, such as one comprising a data processor (DP) 18, a memory (MEM) 20 coupled to the DP 18, and a suitable RF transceiver (TRANS) 22 (having a transmitter (TX) and a receiver (RX)) coupled to the DP 18. The MEM 20 stores a program (PROG) 24. The TRANS 22 is for bidirectional wireless communications with the MP2 16. Note that the TRANS 22 has at least one antenna to facilitate communication. The MP2 16 includes a data processor (DP) 26, a memory (MEM) 28 coupled to the DP 26, and a suitable RF transceiver (TRANS) 30 (having a transmitter (TX) and a receiver (RX)) coupled to the DP 26. The MEM 28 stores a program (PROG) 32. The TRANS 30 is for bidirectional wireless communications with the MP1 14. Note that the TRANS 30 has at least one antenna to facilitate communication. The MP2 16 is coupled via a data path 34 to one or more additional mesh points, external networks or systems, such as the internet 36, for example. Furthermore, the MP1 14 may also be coupled via a data path (not shown) to one or more additional mesh points, external networks or systems, such as the internet, for example.

At least one of the PROGs 24, 32 is assumed to include program instructions that, when executed by the associated DP, enable the electronic device to operate in accordance with the exemplary embodiments of this invention, as discussed herein.

In general, the various exemplary embodiments of the MP1 14 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by one or more of the DPs 18, 26 of the MP1 14 and the MP2 16, or by hardware, or by a combination of software and hardware. As a non-limiting example, one or more of the individual components of MP1 14 and/or MP2 16 may be implemented utilizing one or more integrated circuits (ICs) or application specific integrated circuits (ASICs).

The MEMs 20, 28 may be of any type suitable to the local technical environment and may be implemented using any suitable data storage technology, such as semiconductor based memory devices, magnetic memory devices and systems, optical memory devices and systems, fixed memory and removable memory, as non-limiting examples. The DPs 18, 26 may be of any type suitable to the local technical environment, and may include one or more of general purpose computers, special purpose computers, microprocessors, digital signal processors (DSPs) and processors based on a multi-core processor architecture, as non-limiting examples.

The exemplary embodiments of this invention provide a novel unicast acknowledged management frame, also referred to for convenience as a request to trigger frame. The request to trigger frame is used to request the receiver (peer MP) of the frame to send a trigger frame to the MP that transmitted the management frame. Further in this regard the request to trigger frame may be considered as a re-transmission of a traffic indication map (TIM) bit from the beacon. The request to trigger frame may be sent after some timeout period subsequent to the MP transmitting the beacon frame, where the expiration of the timeout period indicates that the expected trigger frame was not received by the MP that transmitted the beacon.

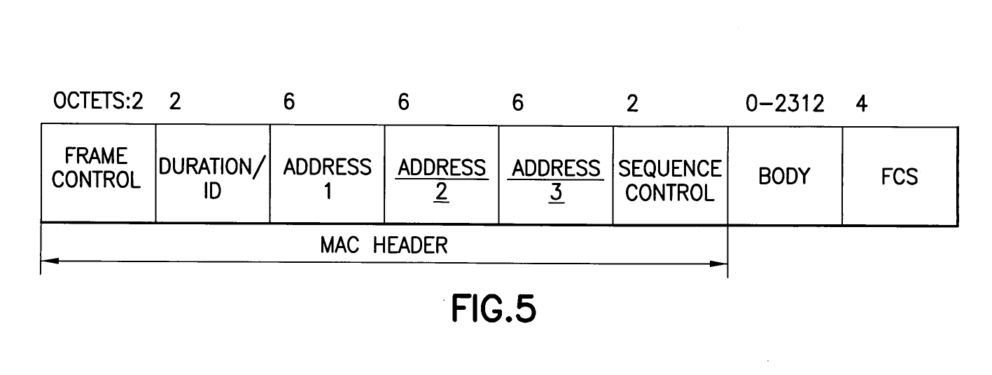

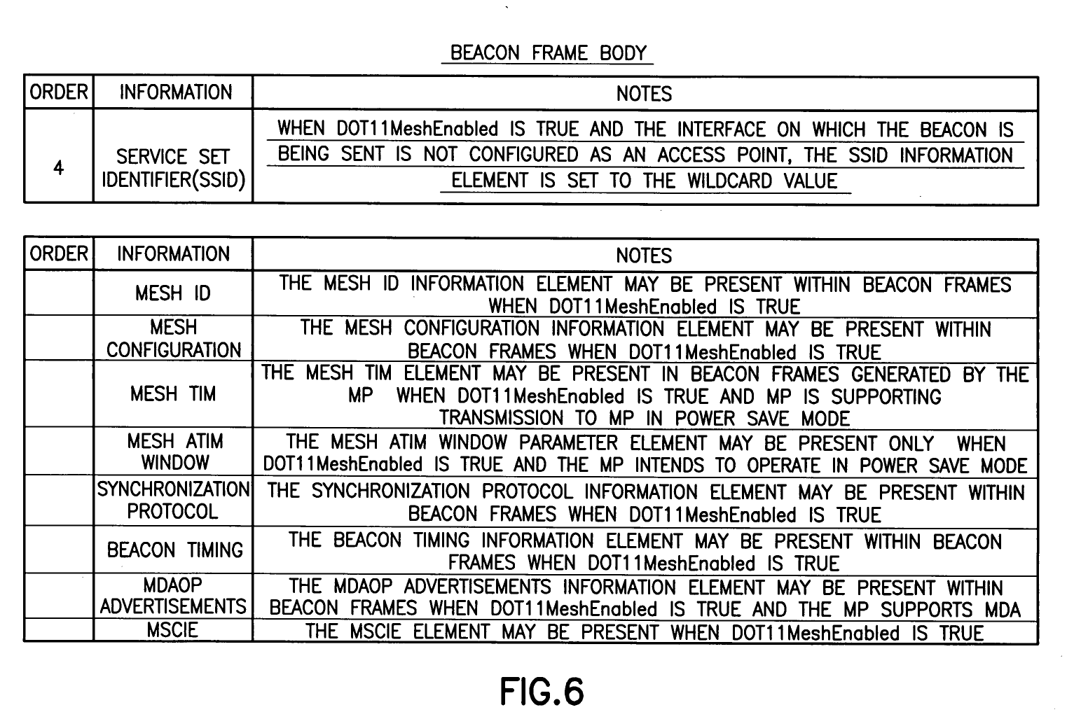

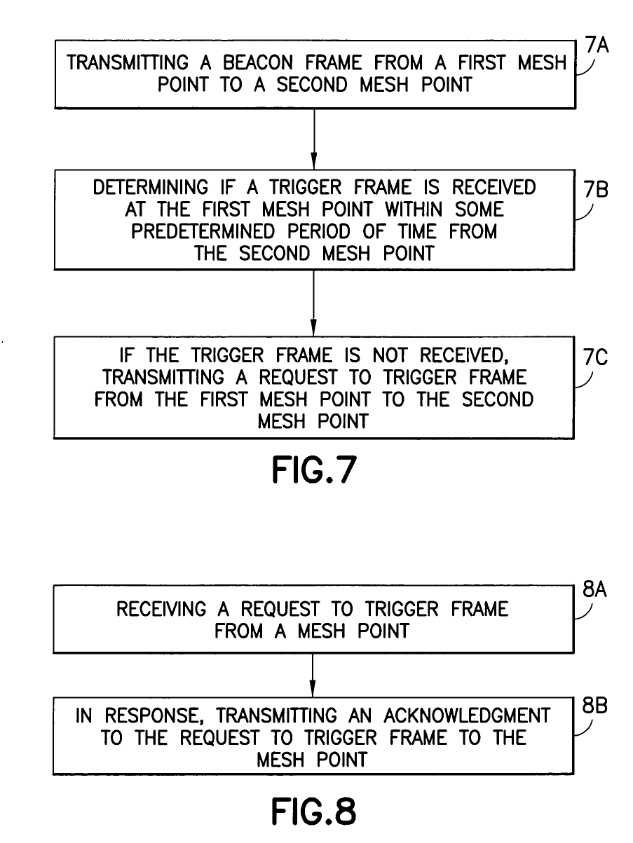

FIG. 5 reproduces FIG. 7-18 of the IEEE P802.11s™ Draft Standard, and shows the management frame format, while FIG. 6 reproduces Table 7-8 of the IEEE P802.11s™ Draft Standard, and shows the beacon frame body format.

If the request to trigger frame is acknowledged, the transmitting MP knows that the peer MP is awake, and also knows that it has received an indication of buffered frames. The transmitting MP (the one that transmits the request to trigger frame) remains in the awake state until it has received a trigger frame, or the MP transmits a new beacon frame which does not indicate buffered traffic. In addition, the peer MP (the receiver of the request to trigger frame) has been explicitly informed that it needs to send a trigger frame.

If the transmission of the request to trigger frame is not successful, the frame is preferably re-transmitted at least once, but need not be necessarily re-transmitted as many times as access category-specific re-transmission rules may specify. If the re-transmission(s) of the request to trigger frame fails, the transmitting MP need not wait for receipt of the trigger frame from the peer MP and may return to the doze state.

In some embodiments the beaconing MP may indicate buffered traffic for peer MPs in the beacon frame, where the peer MPs are operating in a power save mode when they are listening to beacons. The beaconing MP needs to receive trigger frames from all these peer MPs, or it needs to transmit request to trigger frame(s) (and then receive no response to the request to trigger frame(s)), before the beaconing MP may return to the doze state.

The use of the request to trigger frame is advantageous at least in those cases where the MPs operate in the power save mode when listening to beacons, and where the beaconing MP has indicated buffered traffic for the peer MP in its beacon, but has not received a trigger frame from the peer MP. In such a case it is likely that the peer MP has failed to receive the beacon frame, and thus does not know that it should transmit a trigger frame. For example, the peer MP may have entered into the doze state, thereby requiring the local MP to wait until the next beacon transmission, or until the frame(s) expire in the transmission buffer. By the use of these exemplary embodiments the beaconing MP is enabled to obtain information as to whether the peer MP is in the doze state or the awake state.

As currently specified management frames do not trigger service periods. As such, the use of the management frame for sending the request to trigger does not affect service period triggering.

Note that the acknowledgment sent by the peer MP may be a specific acknowledgment message, followed by the trigger frame, or it may simply be the trigger frame.

FIG. 7 is a logic flow diagram that illustrates the operation of a method by a beaconing MP, and a result of execution of computer program instructions, in accordance with the exemplary embodiments of this invention. In the method, and at Block 7A, there is a step of transmitting a beacon frame from a first mesh point to a second mesh point; at Block 7B a step of determining if a trigger frame is received at the first mesh point within some predetermined period of time from the second mesh point; and at Block 7C a step of, if the trigger frame is not received, transmitting a request to trigger frame from the first mesh point to the second mesh point.

The method of the preceding paragraph, further comprising determining if an acknowledgment to the request to trigger frame is received from the second mesh point and, if it is not, re-transmitting at least once the request to trigger frame.

The method of the preceding paragraphs, where the request to trigger frame is transmitted as a unicast management frame.

The method of the preceding paragraphs, where if an acknowledgment to the request to trigger frame is not received from the second mesh point, the method further includes placing the first mesh point in a reduced power consumption mode of operation.

The method of the preceding paragraphs, where if an acknowledgment to the request to trigger frame is received from the second mesh point, the method further includes maintaining the first mesh point in a current power consumption mode of operation.

The method of the preceding paragraphs, where the acknowledgment to the request to trigger frame comprises the trigger frame.

FIG. 8 is a logic flow diagram that illustrates the operation of a method by a peer MP, and a result of execution of computer program instructions, further in accordance with the exemplary embodiments of this invention. In the method, and at Block 8A, there is a step of receiving a request to trigger frame from a mesh point and, at Block 8B, in response transmitting an acknowledgment to the request to trigger frame to the mesh point.

The method of the preceding paragraph, where the acknowledgment comprises a trigger frame.

It should be noted that a given one of the MPs 14, 16 of FIG. 4 may operate at one time as the beaconing MP in accordance with the method of FIG. 7, and at another time as the peer MP in accordance with the method of FIG. 8.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the IEEE P802.11s system, it should be appreciated that the exemplary embodiments of this invention are not limited for use with only this one particular type of wireless communication system, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
transmitting a beacon frame from a first mesh point to a second mesh point;
determining if a trigger frame is received at the first mesh point within some predetermined period of time from the second mesh point; and
if the trigger frame is not received, transmitting a request to trigger frame from the first mesh point to the second mesh point.

2. The method of claim 1, further comprising determining if an acknowledgment to the request to trigger frame is received from the second mesh point and, if it is not, re-transmitting at least once the request to trigger frame.

3. The method of claim 1, where the request to trigger frame is transmitted as a unicast management frame.

4. The method of claim 1, where if an acknowledgment to the request to trigger frame is not received from the second mesh point, placing the first mesh point in a reduced power consumption mode of operation.

5. The method of claim 1, where if an acknowledgment to the request to trigger frame is received from the second mesh point, maintaining the first mesh point in a current power consumption mode of operation.

6. The method of claim 1, where an acknowledgment to the request to trigger frame is received from the second mesh point, the acknowledgment comprising a trigger frame.

7. A computer-readable medium that stores program instructions, the execution of which results in operations that comprise:
transmitting a beacon frame from a first mesh point to a second mesh point;
determining if a trigger frame is received at the first mesh point within some predetermined period of time from the second mesh point; and
if the trigger frame is not received, transmitting a request to trigger frame from the first mesh point to the second mesh point.

8. The computer-readable medium of claim 7, further comprising determining if an acknowledgment to the request to trigger frame is received from the second mesh point and, if it is not, re-transmitting at least once the request to trigger frame.

9. The computer-readable medium of claim 7, where the request to trigger frame is transmitted as a unicast management frame.

10. The computer-readable medium of claim 7, where if an acknowledgment to the request to trigger frame is not received from the second mesh point, further comprising an operation of placing the first mesh point in a reduced power consumption mode of operation.

11. The computer-readable medium of claim 7, where if an acknowledgment to the request to trigger frame is received from the second mesh point, further comprising an operation of maintaining the first mesh point in a current power consumption mode of operation.

12. The computer-readable medium of claim 7, where an acknowledgment to the request to trigger frame is received from the second mesh point, the acknowledgment comprising a trigger frame.

13. An apparatus, comprising:
a wireless transmitter that comprises part of a first mesh point;
a wireless receiver that comprises part of the first mesh point; and
a control unit configurable to transmit a beacon frame from the first mesh point to a second mesh point, to determine if a trigger frame is received from the second mesh point within some predetermined period of time and, if the trigger frame is not received, to transmit a request to trigger frame to the second mesh point.

14. The apparatus of claim 13, said control unit being further configurable to determine if an acknowledgment to the request to trigger frame is received from the second mesh point and, if it is not, to re-transmit at least once the request to trigger frame.

15. The apparatus of claim 13, where the request to trigger frame is transmitted as a unicast management frame.

16. The apparatus of claim 13, where if an acknowledgment to the request to trigger frame is not received from the second mesh point, said control unit is further configurable to place the first mesh point in a reduced power consumption mode of operation.

17. The apparatus of claim 13, where if an acknowledgment to the request to trigger frame is received from the second mesh point, said control unit is further configurable to maintain the first mesh point in a current power consumption mode of operation.

18. The apparatus of claim 13, where an acknowledgment to the request to trigger frame that is received from the second mesh point comprises a trigger frame.

19. A method, comprising:
receiving a request to trigger frame at a first mesh point from a second mesh point; and
in response, transmitting an acknowledgment to the request to trigger frame to the second mesh point.

20. The method of claim 19, where the acknowledgment comprises a trigger frame.

21. A computer-readable medium that stores program instructions, the execution of which results in operations that comprise:
receiving a request to trigger frame at a first mesh point from a second mesh point; and
in response, transmitting an acknowledgment to the request to trigger frame to the second mesh point.

22. The computer-readable medium of claim 21, where the acknowledgment comprises a trigger frame.

23. An apparatus, comprising:
a wireless transmitter that comprises part of a first mesh point;
a wireless receiver that comprises part of the first mesh point; and
a control unit configurable to respond to a receipt of a request to trigger frame from a second mesh point by transmitting an acknowledgment to the request to trigger frame to the second mesh point.

24. The apparatus of claim 23, where the acknowledgment comprises a trigger frame.
